(19) United States
(12) Patent Application Publication
(10) Pub. No.: US 2013/0212085 A1
(43) Pub. Date: Aug. 15, 2013

(54) Parallelizing Query Optimization

(71) Applicants: Anisoara NICA, Waterloo (CA); Ian Lorne Charlesworth, Kingston (CA)

(72) Inventors: Anisoara NICA, Waterloo (CA); Ian Lorne Charlesworth, Kingston (CA)

(73) Assignee: iAnywhere Solutions, Inc., Dublin, CA (US)

(21) Appl. No.: 13/369,500

(22) Filed: Feb. 9, 2012

(51) Int. Cl. G06F 17/30

(52) U.S. Cl. 707/718; 707/E17.131

(57) ABSTRACT

A system, computer-implemented method, and computer-program product embodiments for generating an access plan. A query optimizer includes an enumeration method which enumerates a plurality of subsets of a query. Each subset in the query has a plurality of partitions. The partitions of each subset are enumerated into enumerated partitions using at least one thread. For each partition, physical access plans are generated, using at least one thread. Physical access plans are generated in parallel with other physical access plans of different partitions and with other enumerating partitions. The number of threads that perform the enumeration and the generation is dynamically adapted according to a pool of threads available during the enumeration of the partitions and the generation of physical access plans, and a complexity of the query. From the generated physical access plans, a final access plan for the query is determined by choosing the most efficient access plan.

### BACKGROUND OF THE INVENTION

1. Field of Invention

The invention relates generally to databases and more specifically to query optimization.

2. Description of the Background Art

Computer databases have become a prevalent means for data storage and retrieval. A database user will commonly access the underlying data in a database using a Database Management System (“DBMS”). A user issues a query to the DBMS that conforms to a defined query language. When a DBMS receives a query, it determines an access plan for the query. Once determined, the DBMS then uses the access plan to execute the query. Typically, the access plan is determined from a plurality of possible access plans. The possible access plans are enumerated and the most efficient access plan is chosen. Because algorithms for enumerating, determining the cost, and comparing access plans are sequential, the most efficient access plan to execute the query is chosen in a sequential manner. Thus, what is needed are a system, method, and computer program product that determine access plans for a query in a parallel fashion, including parallelizing multiple subtasks for generating the access plans.

### BRIEF SUMMARY OF THE INVENTION

System, computer-implemented method, and computer-program product embodiments for generating an access plan are provided. A query optimizer is provided with an enumeration method which enumerates a plurality of subsets of a query. Each subset in the query has a plurality of partitions. The partitions of each subset are enumerated into enumerated partitions using at least one thread. For each partition, physical access plans are generated, using at least one thread. Physical access plans are generated in parallel with other physical access plans of different partitions and with other enumerating partitions. The number of threads that perform the enumeration and the generation is dynamically adapted according to a pool of threads available during the enumeration of the partitions and the generation of physical access plans, and a complexity of the query. From the generated physical access plans, a final access plan for the query is determined by choosing the most efficient access plan.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the claimed invention and, together with the description, further serve to explain the principles of the invention and to enable a person skilled in the relevant art to make and use the invention.

FIG. 1 is an example database computing environment in which embodiments of the claimed invention can be implemented.

FIG. 2 is a block diagram for generating an access plan for a query in parallel, according to an embodiment.

FIG. 3 is a sequence diagram for using multiple threads to generate physical access plans in parallel, according to an embodiment.

FIG. 4 is a flowchart of a method for generating an access plan for a query in parallel, according to an embodiment.

FIG. 5 is a flowchart of a method for enumerating partitions in parallel, according to an embodiment.

FIG. 6 is a flowchart of a method for determining physical access plans for the enumerated partitions in parallel, according to an embodiment.

FIG. 7 is a block diagram of an example computer system in which embodiments of the claimed invention may be implemented.

The claimed invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

### I. Introduction

The following detailed description of the claimed invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It will be apparent to a person skilled in the art that the claimed invention, as described below, can be implemented in many different embodiments of software, hardware, firmware, and/or the entities illustrated in the figures. Any actual software code with the specialized control of hardware pseudo code to implement the claimed invention is not limiting of the claimed invention. Thus, the operational behavior of the claimed invention will be described with the understanding that modifications and variations of the embodiments are possible, given the level of detail presented herein.

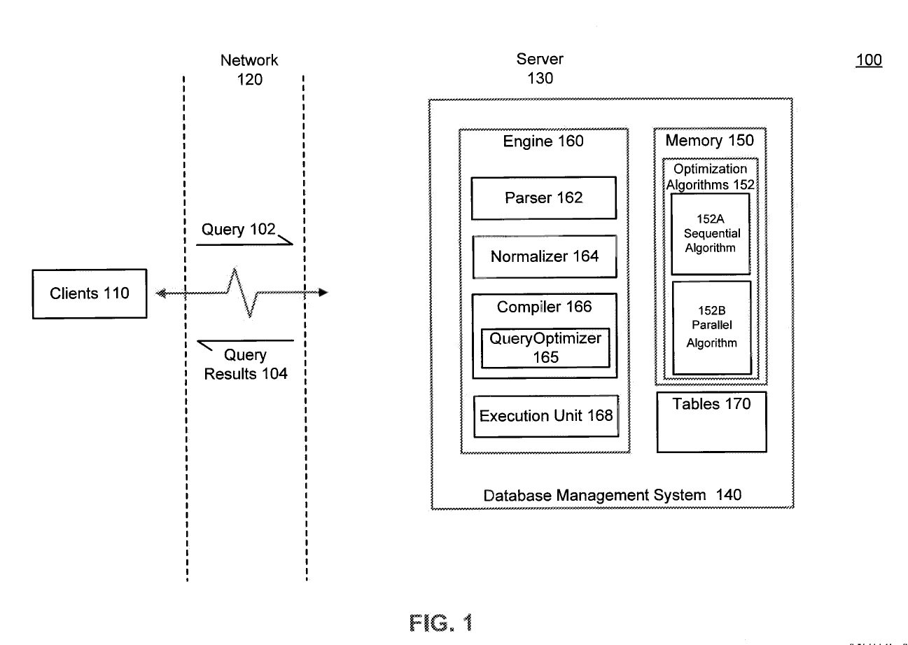

FIG. 1 is an example database computing environment 100 in which embodiments of the claimed invention can be implemented. A client 110 is operable to communicate with a database server 130 using DBMS 140. Although client 110 is represented in FIG. 1 as a separate physical machine from DBMS 140, this is presented by way of example, and not limitation. In an additional embodiment, client 110 occupies the same physical system as DBMS 140. In a further embodiment, client 110 is a software application which requires access to DBMS 140. In another embodiment, a user may operate client 110 to request access to DBMS 140. Throughout this specification, the terms client and user will be used interchangeably to refer to any hardware, software, or human requestor, such as client 110, accessing DBMS 140 either manually or automatically.

DBMS 140 receives a query, such as query 102, from client 110. Query 102 is used to request, modify, append, or otherwise manipulate or access data in database storage 170. Query 102 is transmitted to DBMS 140 by client 110 using syntax which conforms to a query language. In a non-limiting embodiment, the query language is a Structured Query Language (“SQL”), but may be another query language. DBMS 140 is able to interpret query 102 in accordance with the query language and, based on the interpretation, generate requests to database storage 170.

Query 102 may be generated by a user using client 110 or by an application executing on client 110. Upon receipt, DBMS 140 begins to process query 102. Once processed, the result of the processed query is transmitted to client 110 as query result 104.

To process query 102, DBMS 140 includes a parser 162, a normalizer 164, a compiler 166, and an execution unit 168.

Parser 162 parses the received queries. In an embodiment, parser 162 may convert query 102 into a binary tree data structure which represents the format of query 102. In other embodiments, other types of data structures may be used.

When parsing is complete, parser 162 passes the parsed query to a normalizer 164. Normalizer 164 normalizes the parsed query. For example, normalizer 164 eliminates redundant data from the parsed query. Normalizer 164 also performs error checking on the parsed query that confirms that the names of the tables in the parsed query conform to the names of tables in data storage 170. Normalizer 164 also confirms that relationships among tables, as described by the parsed query, are valid.

Once normalization is complete, normalizer 164 passes the normalized query to compiler 166. Compiler 166 compiles the normalized query into machine-readable format. The compilation process determines how query 102 is executed by DBMS 140. To ensure that query 102 is executed efficiently, compiler 166 uses a query optimizer 165 to generate an access plan for executing the query.

Query optimizer 165 analyzes the query and determines an access plan for executing the query. The access plan retrieves and manipulates information in the database storage 170 in accordance with the query semantics. This may include choosing the access method for each table accessed, choosing the order in which to perform a join operation on the tables, and choosing the join method to be used in each join operation. As there may be multiple strategies for executing a given query using combinations of these operations, query optimizer 165 generates and evaluates a number of strategies from which to select the best strategy to execute the query.

To generate an access plan, query optimizer 165 divides a query into multiple subsets. Each subset may be part of a larger set that is a union of multiple subsets or be subdivided into other subsets. Query optimizer 165 then determines an access plan for each subset. Once the access plan for each subset is determined, query optimizer 165 combines the access plan for each subset to generate a best or optimal access plan for the query. One skilled in the relevant art will appreciate that the “best” or “optimal” access plan selected by query optimizer 165 is not necessarily the absolute optimal access plan which could be implemented, but rather an access plan which is deemed by rules designed into query optimizer 165 to be the best of those access plans as determined by some objective or subjective criteria or rules.

Query optimizer 165 may generate the access plan using one or more optimization algorithms 152. Optimization algorithms 152 are stored in memory 150 of DBMS 140. Query optimizer 165 may select a single algorithm 152 or multiple algorithms 152 to generate an access plan for a query. For example, query optimizer 165 may generate an access plan for each subset using a particular algorithm 152.

Optimization algorithms 152 may be sequential algorithms, such as algorithms 152A. Algorithms 152A are algorithms that create an access plan for each subset of query 102 sequentially. Algorithms 152A typically use a single thread (also referred to as a main thread) to receive query 102, break query 102 into multiple subsets, enumerate the partitions in each subset sequentially, sequentially generate an access plan for each subset, and combine the access plan from each subset into a best access plan for query 102.

Optimization algorithms 152 may also be parallel algorithms, such as algorithms 152B. In an embodiment, algorithms 152B create an access plan using multiple threads executing on a single or multiple computer processing units in parallel. To create an access plan in parallel, algorithms 152B may parallelize certain work during the access plan enumeration and generation. To parallelize the work, parallel algorithms 152B attempt to spawn multiple threads to generate access plans for each subset when certain conditions (examples of which are described below) are met.

In an embodiment, when conditions are met, parallel algorithms 152E spawn new threads when threads are available in the DBMS 140. When parallel algorithm 152B cannot spawn a new thread due to limited system resources, the work is performed by the main thread or an already spawned thread has completed its designated work. This results in the number of threads being adjusted to the availability of system resources of DBMS 140. Thus, when resources of DBMS 140 are busy with other processes, fewer threads are spawned to determine an access plan for query 102. On the other hand, when resources of DBMS 140 are free, more threads may be spawned to determine the access plan for query 102.

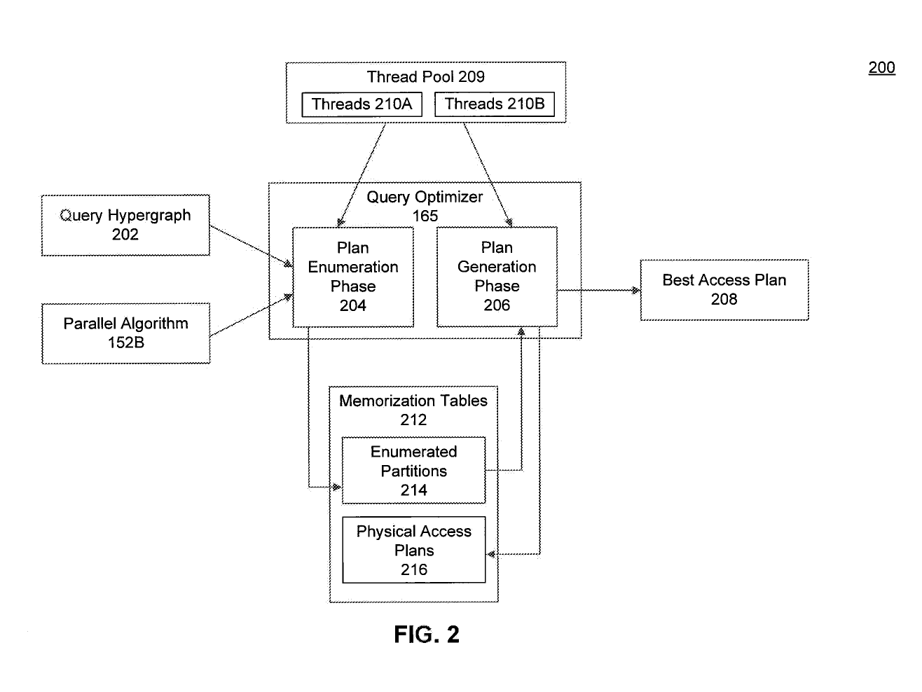

FIG. 2 is a block diagram 200 for generating an access plan for a query in parallel, according to an embodiment.

In an embodiment, algorithms 152 may be partition based algorithms. Partition based algorithms determine a best access plan 208 for query 102 from a set of vertices (“set V”) of query hypergraph 202. Query hypergraph 202 may be generated from the binary tree structure generated from query 102. Query hypergraph 202 depicts relationships between the database tables stored in the database storage 170 as defined by the query 102. Different methods for generating set V of query hypergraph 202 are known to a person skilled in the relevant art.

Example partitioned based algorithms include a Top-Down Partition Search Algorithm, DPhys Algorithm, and ordered-DPhys Algorithm, all of which are known to a person skilled in the art.

Partition based algorithms use query hypergraph 202 associated with query 102 to divide query 102 into multiple subsets, such as an exemplary subset S. Each subset is divided into multiple logical partitions. Each logical partition may be of form (S₁, S₂) that corresponds to a logical join of subsets (S₁) [symbol] (S₂) for subset S=S₁ ∪ S₂, where S⊂ V (where V is a set of vertices of the query hypergraph 202). Partition based algorithms then determine an access plan for each logical partition.

Partition based algorithms include a plan enumeration phase 204 and a plan generation phase 206.

In plan enumeration phase 204, partition based algorithms enumerate logical partitions. For example, during plan enumeration phase 204 for each subset S, partition based algorithm enumerates partitions (S₁, S₂) corresponding to the logical join (S₁) [symbol] (S₂) for a subset S=S₁ ∪ S₂, where S ⊂ V. In an embodiment, partitions for a subset S may be enumerated in a random order and may be enumerated in different stages of plan enumeration phase 204. Enumerated partitions that meet the criteria of a particular partition based algorithm are then stored in a memoization table 212. The criteria may be specific to the partition based algorithm and is outside of the scope of this patent application.

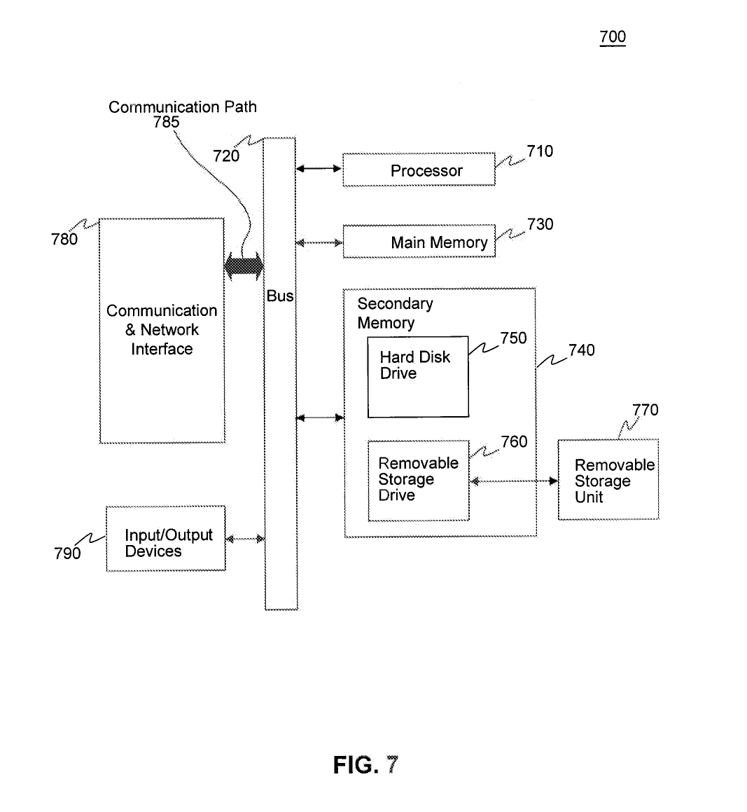

Memoization table 212 stores enumerated partitions, such as enumerated partitions 214. Enumerated partitions 214 are partitions that were enumerated during plan enumeration phase 204. Memoization table 212 may be included in system memory 150 which maybe any type of memory described in detail in FIG. 7.

Memoization is an optimization technique known to a person skilled in the art. Memoization is a technique where the inputs and outputs of function calls are saved in a memoization table 212. Because the inputs and outputs of the function call are saved, the server avoids processing the function with the same inputs more than once and retrieves an output that is stored in memory 150.

Plan generation phase 206 generates a physical access plan 216 corresponding to each enumerated partition 214. In an embodiment, multiple physical access plans 216 may be generated for each enumerated partition 214. Those physical access plans 216 are also stored in memoization table 212.

Plan generation phase 206 also calculates the estimated execution cost of each physical access plan 216. The execution cost of each physical access plan 216 may also be stored in memoization table 212.

Once physical access plans 216 are generated in plan generation phase 206, a partition algorithm selects a cost effective access plan for each enumerated partition from the generated physical access plans. The methodology for selecting a cost effective access may depend on available system resources in DBMS 140 or another methodology known to a person skilled in the art. The selected physical access plan 216 for each enumerated partition 214 is then combined into best access plan 208 for query 102.

In an embodiment, parallel algorithms 152B that are partition algorithms enumerate the logical partitions during plan enumeration phase 204 and generate physical plans 214 in plan generation phase 206. In an embodiment, plan enumeration phase 204 and plan generation phase 206 may be performed in parallel for different subsets. Example parallel algorithm 152B that may enumerate logical plan partitions and generate physical plans in parallel may be a parallel-ordered-DPhyp algorithm. The parallel ordered-DPhyp algorithm is a parallel implementation of an ordered-DPhyp algorithm, which is known to a person skilled in the relevant art. For example, a person skilled in the art will appreciate that the ordered-DPhyp algorithm is a combination of a DPhyp algorithm, which is a dynamic programming algorithm for enumerating bushy-trees and an ordered-Par algorithm.

To determine a subset S that may be processed in parallel during the plan enumeration phase 204 and phase generation phase 206, parallel algorithms 152B may include certain conditions or invariants. Example invariants for the ordered-DPhyp algorithm are described below, though other invariants may also be defined. When one or more of those invariants are true, parallel algorithm 152B causes query optimizer 165 to spawn multiple threads 210 that may execute in parallel during plan enumeration phase 204 and/or plan generation phase 206. Threads 210 that spawn other threads are referred to as threads 210A. Threads 210 that are being spawned by threads 210A are referred to as threads 210B.

Threads 210 may be included in thread pool 209. A number of threads 210 in thread pool 209 may depend on the available resources in DBMS 140. When DBMS 140 does not have available resources or threads 210 are busy processing allocated work, thread pool 209 may be empty. In this case, thread 210A may continue to execute the work in sequence or wait for thread 210B to become available in thread pool 209.

The first invariant (also referred to as invariant A) is that each subset S of query 102 passes through plan enumeration phase 204 and plan generation phase 206. For example, for query optimizer 165 to use parallel algorithm 152B to generate an access plan for query 102 in parallel, each subset S of query 102 passes through plan enumeration phase 204 and plan generation phase 206.

In an embodiment, plan enumeration phase 204 may include several stages. For example, plan enumeration phase 204 for each subset S (also referred to as PEP(S)) may include a before_PEP(S) stage, a PEP(S) stage and an end_PEP(S) stage. During the PEP(S) stage, query optimizer 165 uses parallel algorithm 152B to enumerate at least one partition (S₁, S₂), S=S₁ ∪ S₂. The enumerated partition is then stored in memoization table 212 as enumerated partition 214. In the before_PEP(S) stage, no partitions in subset S are enumerated using parallel algorithm 152B. In the end_PEP(S) stage, all partitions in set S are enumerated using parallel algorithm 152B.

In another embodiment, plan generation phase 206 (also referred to as PGP(S)) also includes several stages for processing each subset S. In an embodiment, parallel algorithm 152B begins plan generation phase 206 on enumerated partitions 214. For example, each enumerated partition 214 for subset S may be in before_PGP(S) stage, PGP(S) stage, and end_PGP(S) stage. In the PGP(S) stage, at least one enumerated partition 214, such as partition (S₁, S₂), has its physical access plans 216 generated and costed. When physical access plan 216 is costed, the expense of executing physical access plan 216 is determined. The cost of executing physical access plan 216 may be determined in terms of CPU time and DBMS 140 resources. Numerous methods for determining a cost of physical access plan 216 are known to a person skilled in the relevant art, and are outside of the scope of this patent application.

In the before_PGP(S) stage, physical access plans 216 are not generated for any enumerated partitions 214 in subset S. In the end_PGP(S) stage, physical access plans 216 are generated for all enumerated partitions 214 in subset S.

In an embodiment, plan generation phase 206 also includes a partition plan generation phase (also referred to as PPGP(S₁, S₂), where S₁ and S₂ are partitions that make up another set (or subset) S). During the PPGP(S₁, S₂), parallel algorithm 152B generates physical partition plan 216 for a partition (S₁, S₂), where set S=S₁ ∪ S₂, and determines the expense for executing the generated physical access plan 216. When a partition of set S is in a PPGP(S₁, S₂) stage, the subsets Si for i=1, 2 that comprise the partition are in the ended_PGP(Si) stage, while set S is in PGP(S) stage.

As with other phases, PPGP(S₁, S₂) may be divided into the before_PPGP(S₁, S₂) stage, PPGP(S₁, S₂) stage and end_PPGP(S₁, S₂) stage. During the before_PPGP(S₁, S₂) stage, parallel algorithm 152B has not generated any physical access plans 216 for partition (S₁, S₂) in set S. During the PPGP(S₁, S₂) stage, parallel algorithm 152B generates physical access plans 216 for partition (S₁, S₂) of set S. During the end_PPGP(S₁, S₂) stage, parallel algorithm 152B has generated all physical access plans 216 for partition (S₁, S₂) of set S. In end_PPGP(S₁, S₂), parallel algorithm 152B also has determined the expense for executing each physical access plan 216 for partition (S₁, S₂) of set S. Additionally, in the end_PPGP(S₁, S₂) stage parallel algorithm 152B has compared and saved the best physical access plans 216 for partition (S₁, S₂) in memoization table 212.

Another invariant (also referred to as invariant B) for parallel algorithm 152B to generate best access plan 208 in parallel is when subset S is used in the PEP(S) stage for partition (S, X) of a bigger set S ∪ X, subset S must be in the end_PEP(S) stage. In other words, a plan enumeration phase for subset S must be complete, before a plan enumeration phase for a larger subset X, that also includes subset S, is started.

Another invariant (also referred to as invariant C) for parallel algorithm 152B is when subset S is used in PPGP(S, X) stage for a partition (S, X) of a bigger set S ∪ X, subset S must be in the end_PGP(S) stage. In other words, an access plan for subset S must be generated and costed by parallel algorithm 152B and stored in memoization table 212.

Another invariant, (also referred to as invariant D) for parallel algorithm 152B is when subset S is in the PEP(S) stage, its partitions are enumerated in any order and may be interleaved with other subsets that are in the PEP stage as long as invariant B and invariant C are true. For example, partitions S₁ and S₂ may both be in plan enumeration phase 204 as long as partition S₁ and partition S₂ are not included in each other's partitions.

In an embodiment, some parallel algorithms 152B may perform plan enumeration phase 204 and plan generation phase 206 on subsets S simultaneously, while other algorithms 152B, such as a ordered-DPhys algorithm, complete plan enumeration phase 204 for all subsets S for query 202 prior to beginning plan generation phase 206 for any subset S.

In an embodiment, parallel algorithm 152B may exploit invariants B and C to parallelize plan enumeration phase 204, plan generation phase 206 and partition plan generation phase of different subsets S for query 102. In an embodiment, parallel algorithms 152B attempt to parallelize work such that the same entries (such as enumerated partitions 214 or physical access plans 216) in a memoization table 212 are not accessed by different threads 210 that process the work in parallel for the same subset S or partition within subset S. For example, two threads 210 may not work on the PPGP phase of two partitions in the same subset S. In other words, costing cannot be performed in parallel by two threads 210 that work on partition (S₁, S₂) and partition (S₃, S₄) of the same subset S. In another example, thread 210 cannot work on a plan generation phase 206 of subset S, while another thread 210 works on the plan enumeration phase 204 of subset S. In other words, costing which is performed in plan generation phase 206 cannot be performed in parallel with enumerating a new partition (which is performed in plan enumeration phase 204) for the set S₁ ∪ S₂.

In an embodiment, best access plan 208 generation process may be parallelized using parallel algorithm 152B when certain conditions are met. As described previously, parallelization of work is possible when there is no contention for entries in memoization table 212 among multiple threads 210.

Example Condition 1: Work can be parallelized in the PPGP for partition (S₁, S₂) of a set S=S₁ ∪ S₂ with another PPGP phase of partition (S₃, S₄) of a set S′=S3 ∪ S4, such that S′≠S.

Example Condition 2: Work can be parallelized in the PPGP phase for a partition (S₁, S₂) of a set S=S₁ ∪ S₂, with a plan enumeration phase 204 of set S′ such that S′ is not a subset of any S₁ and S₂, i.e., S′∩S₁<>S′, and S′∩S₂<>S′.

Example Condition 3: Work can be parallelized in plan enumeration phase 204 for two subsets S and S′ such that S∩S′=O.

### 2. Example Parallel Join Enumeration Algorithm

Below is an example pseudo-code for parallel algorithm 152B that utilizes Invariants A-D and Conditions 1-3 described above.

Parallel Partition Algorithm
Input: The X algorithm, the query hypergraph G(Q)=(V, E)
Output: BestPlan(V)
Plan Enumeration Phase:
   Enumerate partitions using the X algorithm without costing them: call Enumerate Partition(S₁, S₂) to store valid partitions in mTable
Plan Generation Phase:
   Top-down plan generation: call GenerateBestPlan(V)

As described in the pseudo-code above, query optimizer 165 receives a type of parallel algorithm 152B (such as a parallel ordered-DPhys algorithm) and query hypergraph 202 (that may also be defined as G(Q)=(V, E)) of query 102 as inputs. After processing query hypergraph 202 using parallel algorithm 152B, query optimizer 165 outputs best access plan 208 for query 102. The pseudo-code includes plan enumeration phase 204 and plan generation plan 206.

As described herein, parallel algorithm 152B includes plan enumeration phase 204. Example pseudo-code for plan enumeration phase 204 for partitions S₁ and S₂ is below.

```
Enumerate Partition Phase(S₁ , S₂ )
  {Enumeration Phase: Save partitions without costing}
  S = S₁ ∪ S₂ {Keep only [symbol]   partitions}
  if |Partitions(S)| + 1 == [symbol]   then
      for all (S₁, S₂) ε Partitions(S) do
      Compute the score of (S₁, S₂): [symbol]
      Sort Partitions(S) based on the scores
      Compute the score of (S₁, S₂): [symbol]
      Insert (S₁, S₂) in the ordered set Partitions(S)
      Remove the last element of the set Partitions(S)
      return
  Insert (S₁, S₂) in the unordered set Partitions(S)
  Sᵢ must be in end_PEP stage:
  Try starting PGP phase on S₁ and/or S₂ if not already started and a
  thread is available
  If Sᵢ, for any i, is in before_PGP spawn(Sᵢ, PGP)
  return
```

In the example above, during plan enumeration phase 204, partitions in subset S are enumerated into enumerated partitions 214. As partitions in subset S are enumerated, using thread 210A, thread 210A may spawn thread 210B to begin plan generation phase 206 for partitions S₁ that are, in the end_PEP(Si) stage.

As described herein, parallel algorithm 152B also includes plan generation phase 206. Example pseudo-code for plan generation phase 206 is below.

```
GenerateBestPlanPhase(S)
{Costing Phase: Generate plans from the saved partitions of S}
if BestPlan(S) != Null then
      return BestPlan(S)
if Partitions(S) is not ordered then
      for all (S₁, S₂) ε Partitions(S) do
            Compute the score of (S₁, S₂) [symbol]
            Sort Partitions(S) based on the scores
spawn PGP work for enumerated partitions
Sᵢ must be in ended _PEP stage; try starting PGP phase on S₁ and/or S₂
if not already started and a thread is available
for all (S₁, S₂) ε Partitions(S) do
      if Sᵢ for any i is in before PGP spawn(Sᵢ, PGP )
      if both Si are in ended PGP spawn((S₁, S₂), PPGP )
for all (S₁, S₂) ε Partitions(S) do
      work itself on Si if PGP (Si ) is not already started
      if Si for any i is in before PGP GenerateBestPlan(Si)
            work itself on costing (S₁, S₂)
            work itself on PPGP (S₁, S₂) for an enumerated partition
      if both Si are in end_PGP GenerateBestPlan(S, (S₁, S₂))
            add to the waiting list anything that is already in PGP
      if Si is in PGP then waiting list.add( Si, (S₁, S₂))
{Algorithm finished all the work we could have done:}
{We have to wait for work started by others}
while waiting list is empty do
      wait( waiting list )
      if wakeup by ( Si , (S₁, S₂)) then
            GenerateBestPlan(S, (S₁, S₂))
      waiting list.delete( Si , (S₁, S₂))
```

As described above, during plan generation phase 206, physical access plans 216 for partitions included in subset S are generated and costed. As physical access plans 216 for partitions are generated using multiple threads 210, those threads may spawn threads 210B to process partitions within subset S, as long as conditions 1-3 are met.

3. Example Implementation for Generating a Physical Access Plan from Partitions of a Query

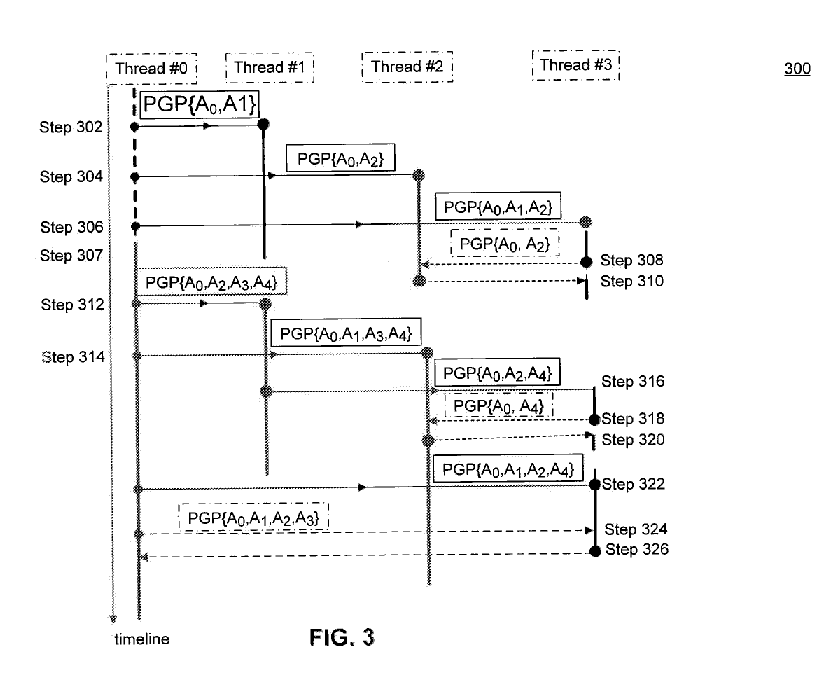

FIG. 3 is an operational sequence diagram 300 for generating physical access plans in parallel, according to an embodiment.

In sequence diagram 300, parallel algorithm 152B generates best access plan 208 for query 102 using four threads 210. Example threads 210 are Thread #0, Thread #1, Thread #2 and Thread #3, as shown in FIG. 3, for a query whose set V={A₀, A₁, A₂, A₃, A₄}.

Thread #0 may be a main thread that determines enumerated partitions, such as partitions below, during plan enumeration phase 204. Typically, the main thread is thread 210A since it may spawn threads 210B as needed. For example, Thread #1, Thread #2 and Thread #3 are threads 210B since there were spawned from Thread #0.

Example partitions in sequence diagram 300 include partitions {A₀, A₁}, {A₀, A₂}, {A₀, A₃}, {A₀, A₄}, {A₀, A₁, A₂}, {A₀, A₁, A₃}, {A₀, A₁, A₄}, {A₀, A₂, A₄}, {A₀, A₂, A₃}, {A₀, A₃, A₄}, {A₀, A₁, A₂, A₃}, {A₀, A₁, A₃, A_{4}, {A}₀, A₂, A₃, A₄}, {A₀, A₁, A₂, A₄}, {A₀, A₁, A₂, A₃, A₄}. Once Thread #0 enumerates example partitions described above, Thread #0 may store those enumerated partitions in memoization table 212.

In this embodiment, when Thread #0 completes plan enumeration phase 204, Thread #0 begins working at plan generation phase 206. In other embodiments, however, plan generation phase 206 on certain partitions may begin before Thread #0 completes plan enumeration phase 204.

In an embodiment described in FIG. 3, Thread #0 generates physical access plan 216 for partitions {A₀, A₁, A₂, A₃, A₄}, {A₀, A₁, A₂, A₄}, and {A₀, A₁, A₄}. Thread #1 generates physical access plans 216 for partitions {A₀, A₁}, {A₀, A₂, A₃, A₄}, {A₀, A₂, A₃} and {A₀, A₃}. Thread #2 generates physical access plans 216 for partitions {A₀, A₂}, {A₀, A₁, A₃, A₄}, {A₀, A₃, A₄}, {A₀, A₄} and {A₀, A₁, A₃}. Thread #3 generates physical access plans 216 for partitions {A₀, A₁, A₂}, {A₀, A₂, A₄} and {A₀, A₁, A₂, A₃}. As illustrated below, Thread #0, Thread #1, Thread #2 and Thread #3 generate physical access plans 216 for partitions above in parallel.

During plan enumeration phase 204, Thread #enumerates partitions for the all subsets of the set {A₀, A₁, A₂, A₃, A₄} and it spawns first Thread #1 to work on PGP({A₀, A₁}) at step 302. Thread #1 begins to generate a physical access plan for partition {A₀, A₁} in parallel with Thread #0. Once Thread #1 completes generating the physical access plan for partition {A₀, A₁}, Thread #1 is returned to thread pool 209.

At step 304, Thread #0 spawns Thread #2 to determine a physical access plan 216 for partition {A₀, A₂}. Once spawned, Thread #2 begins generating the physical access plan 216 for partition {A₀, A₂} in parallel with Thread #0 and Thread #1.

At step 306, Thread #0 spawns Thread #3 to determine a physical access plan 216 for partition {A₀, A₁, A₂}. Once spawned, Thread #3 generates physical access plan 216 for partition {A₀, A₁, A₂} in parallel with Thread #0, Thread #1, Thread #2. As Thread #3 executes, Thread #3 identifies that the physical access plan 216 for partition {A₀, A₂} is being generated by Thread #2. Thread #3, therefore, proceeds to step 308.

At step 307, Thread #0 finishes plan enumeration phase 204 and starts itself plan generation phase 206.

At step 308, Thread #3 waits for Thread #2 to complete generating physical access plan 216 for partition {A₀, A₂}.

At step 310, Thread #2 completes generating physical access plan 216 for partition {A₀, A₂}. Thread #3 then resumes determining physical access 216 plan for partition {A₀, A₁, A₂}. Once Thread #2 determines physical access plan 216 for partition {A₀, A₁, A₂}, Thread #2 may be returned to thread pool 209 to be assigned to determine physical access plan 216 for another partition.

At step 312, Thread #0 retrieves Thread #1 from thread pool 209 to determine physical access plan 216 for partition {A₀, A₂, A₃, A₄}. Once retrieved, Thread #1 begins to determine physical access plan 216 for partition {A₀, A₂, A₃, A₄}.

At step 314, Thread #0 retrieves Thread #2 from thread pool 209 to determine physical access plan 216 for partition {A₀, A₁, A₃, A₄}. Once retrieved, Thread #2 begins to determine physical access plan 216 for partition {A₀, A₁, A₃, A₄}.

As Thread #1 generates physical access plan 216 for partition {A₀, A₂, A₃, A₄}, Thread #1 retrieves Thread #3 from thread pool 209 to generate physical access plan 216 for partition {A₀, A₂, A₄} at step 316. Once retrieved, Thread #3 begins to generate physical access plan 216 for partition {A₀, A₂, A₄}.

At step 318, Thread #3 waits until Thread #2 completes processing partition {A₀, A₂, A₄}, because Thread #3 depends on partition {A₀, A₄}. Thread #3 waits for Thread #2 to complete to avoid accessing the entries in memoization table 212 associated with partitions A₀, and A₄ at the same time as Thread #2.

At step 320, Thread #2 completes generating physical access plan 216 for partition {A₀, A₂, A₄}. Thread #3 then uses generated physical access plan for {A₀, A₂, A₄} to complete generating physical access plan 216 for partition {A₀, A₁, A₃, A₄}. Once completed, Thread #3 may be returned to thread pool 209.

At step 322, Thread #0 retrieves Thread #3 to generate physical access plan 216 for partition {A₀, A₁, A₂, A₃}. As Thread #3 generates physical access plan 216 for partition {A₀, A₁, A₂, A₃}, Thread #0 waits until Thread #3 completes generating physical access plan 216 at step 324.

At step 326, Thread #3 completes generating physical access plan 216 for partition. {A₀, A₁, A₂, A₃}, thus enabling Thread #0 to continue generating physical access plan 216 for partition {A₀, A₁, A₂, A₃, A₄}.

When Thread #0, Thread #1, Thread #2, and Thread #3 complete generating physical access plans 216 for the above partitions, Thread #0 may combine the generated physical access plan into best access plan 208 for query 102 (not shown).

### 4. Example Method for Generating an Access Plan

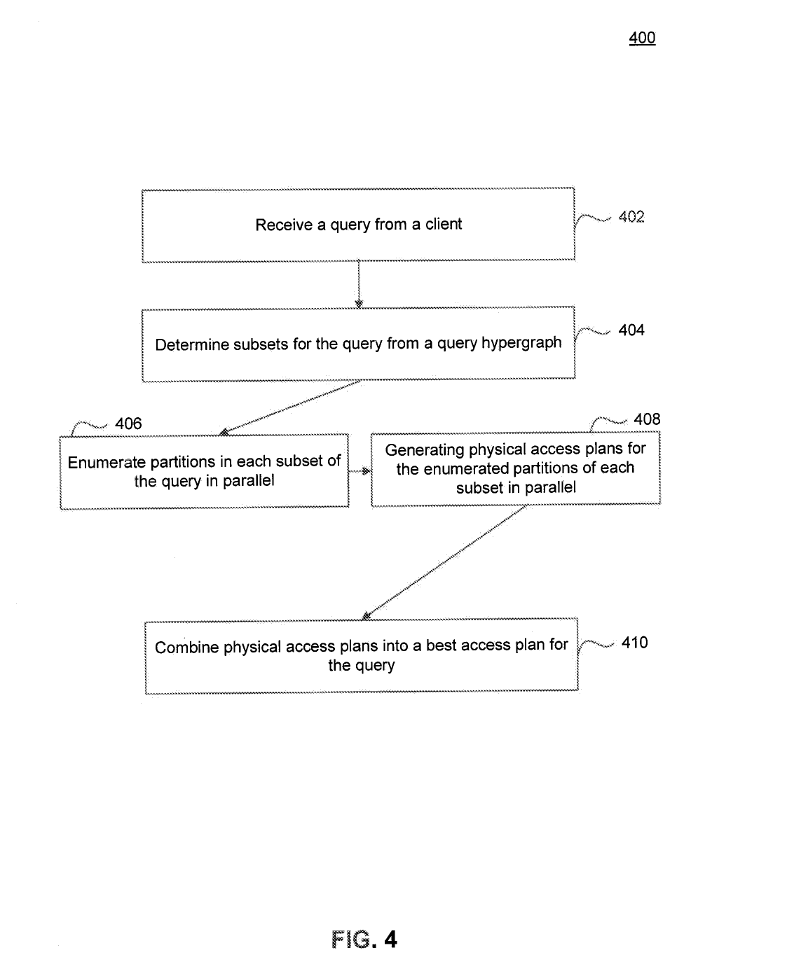

FIG. 4 is a flowchart of a method 400 for generating a best access plan for a query in parallel, according to an embodiment.

At step 402, a query is received. For example, DBMS 140 may receive query 102 from client 110. Upon receipt, query hypergraph 202 of query 102 is determined.

At step 404, subsets of a query are determined. For example, based on query hypergraph 202, subsets Si, for i=0, 1, 2, . . . n of query 102 are determined.

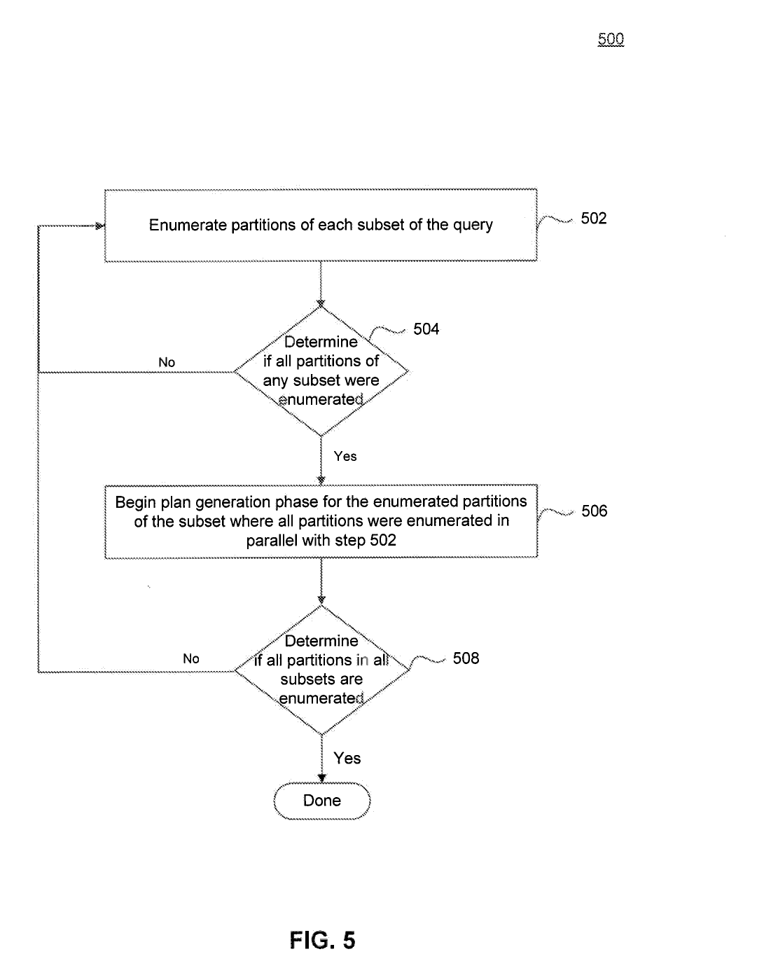

At step 406, a plan enumeration phase is performed. As described herein, during plan enumeration phase 204, query optimizer 165 uses algorithm 152B to enumerate partitions in each subset Sᵢ in parallel. Query optimizer 165 then stores enumerated partitions 214 in memoization table 212. Step 406 is described in detail using FIG. 5.

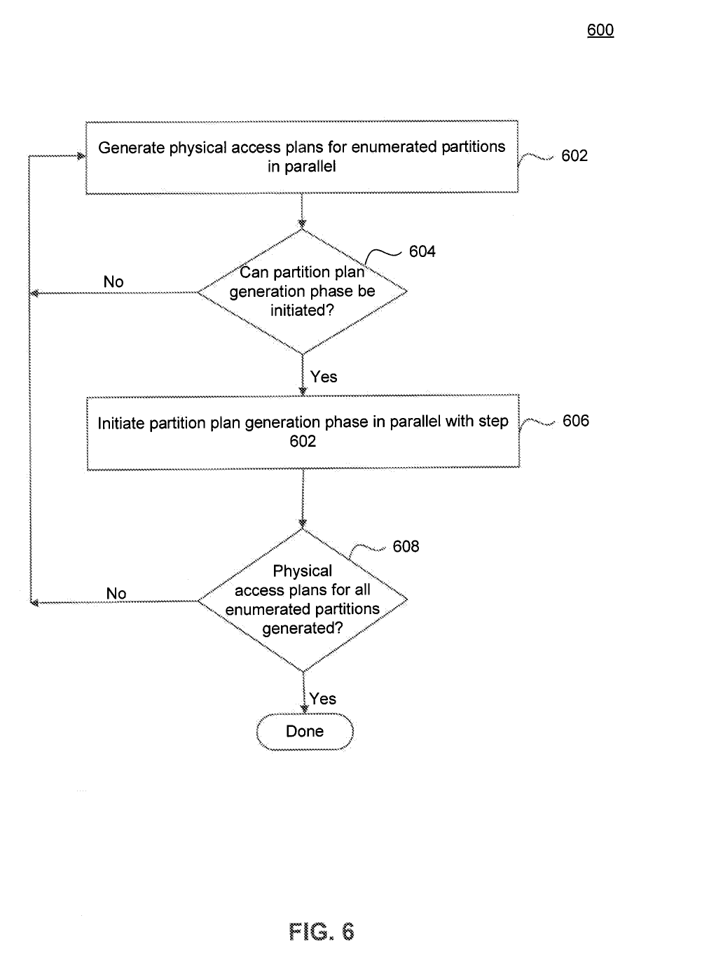

At step 408, plan generation phase is performed for enumerated partitions in parallel. As described herein, during plan generation phase 206 one or more physical access plans 216 are determined for each enumerated partition 214. During plan generation phase 206, the expense for executing each physical access plan 216 may also be determined. Step 408 is described in detail with reference to FIG. 6. Step 406 and step 408 are executed in parallel.

At step 410, a best access plan for a query is generated. For example, query optimizer 165 identifies physical access plan 216 that is least expensive to execute within DBMS 140 for each enumerated partition 214. Once the least expensive physical access plans 216 are identified, query optimizer 165 combines physical access plans 216 for each enumerated partition 214 into best access plan 208 for query 102. As described herein, best access plan 208 manipulates data in tables 170 and causes DBMS 140 to generate and transmit query results 104 to client 110.

FIG. 5 is a flowchart of a method 500 for enumerating partitions in parallel, according to an embodiment. As described herein, prior to plan enumeration phase 204, multiple subsets are generated from query hypergraph 202 for query 102.

At step 502, partitions in each subset are enumerated. As described herein, a subset S that does not include any enumerated partitions is in the before_PEP(S) stage. As thread 210A begins to enumerate partitions in each subset S associated with query 102, the subset enters the PEP(S) stage. Once enumerated, thread 210A stores enumerated partitions 214 for each subset S in memoization table 212.

At step 504, a determination is made whether all partitions of a subset are enumerated. When all partitions of subset S are enumerated, subset S is in the end_PEP(S) stage. If any subset S is in the end PEP(S) stage, the flowchart proceeds to step 506. Otherwise, the flowchart returns to step 502.

At step 506, a physical access plan is generated for the subset that has all partitions enumerated. For example, when all partitions of subset S are enumerated, thread 210A spawns thread 210B to initiate plan generation phase 206 for subset S, in parallel with thread 210A. For example, thread 210A may spawn thread 210B to determine a physical access plan for each subset S that is in the end_PEP(S) stage, while thread 210A continues to enumerate partitions of other subsets.

At step 508, a determination is made as to whether all partitions are enumerated. When all partitions are enumerated, plan enumeration phase 204 is complete. Otherwise, the flowchart proceeds to step 502.

FIG. 6 is a flowchart of a method 600 for determining physical access plans for enumerated partitions in parallel, according to an embodiment.

At step 602, physical access plans for enumerated partitions are generated in parallel. For example, query optimizer 165 begins to generate physical access plans 216 for subsets S, for which plan generation phase 206 was not initiated in step 506. For example, thread 210A identifies enumerated partition 214 that is in the end_PEP(S) stage and spawns thread 210B to determine physical access plan 216 for enumerated partition 214. Thread 210B may be spawned when certain conditions, e.g., the aforementioned conditions 1, 2 or 3, are met with respect to enumerated partition 214 in subset S. In an embodiment, prior to spawning thread 210B, thread 210A determines whether threads 210B are available in thread pool 209. As described above, step 602 may be performed multiple times by one or more threads 210A as long as conditions 1, 2, or 3 are met and threads 210B are available in thread pool 209. When thread pool 209 does not have available thread 210B or conditions 1, 2 and 3 are not met, thread 210A may itself generate physical access plan 216 for enumerated partition 214. Thread 210A may also wait until conditions 1, 2 or 3 for subset S are met.

As described herein, when thread 210B begins generating physical access plan 216 for enumerated partition 214, subset S enters PGP(S) stage. When thread 210B completes generating physical access plans 216 for enumerated partition 214, subset S enters end_PGP(S) stage. Upon completion, thread 210A that spawned thread 210B may return thread 210B to thread pool 209 or assign thread 210B to generate another physical access plan 216. The generated physical access plans 216 are stored in memoization table 212.

At step 604, a determination is made whether a partition plan generation phase (PPGP) may be initiated. As described herein, PPGP for partition (S₁, S₂) for set S=S₁ ∪ S₂ may be initiated, when subsets S₁ for i=1, 2 that make up the partition are in the end_PGP(Si) stage and set S is in PGP(S) stage. When PPGP (S₁, S₂) may be initiated, the flowchart proceeds to stage 606. Otherwise the flowchart proceeds to stage 602.

At step 606, a partition plan generation phase is initiated. For example, thread 210A may spawn threads 210B to generate physical access plan 216 for partitions in the PPGP(S₁, S₂) stage where S=S₁ ∪ S₂. As described herein, thread 210B may be spawned when conditions 1 or 2 are met. Thread 210B executes the partition plan generation phase with step 602.

At step 608, a determination is made as to whether physical access plans for all enumerated partitions were generated. For example, a determination is made as to whether threads 210A and threads 210B have completed PGP(S) stages or PPGP(S₁, S₂) stages where S=S₁ ∪ S₂. When all physical access plans 216 were generated, the flowchart ends. Otherwise, the flowchart proceeds to steps 606 and 602 described above.

### 5. Example Computer System Implementation

Various aspects of the claimed invention can be implemented by software, firmware, hardware, or a combination thereof. FIG. 7 illustrates an example computer system 700 in which the claimed invention, or portions thereof, can be implemented as computer-readable code. For example, the methods illustrated by methods 400 of FIG. 4, 500 of FIGS. 5 and 600 of FIG. 6, can be implemented in system 700. Various embodiments of the invention are described in terms of this example computer system 700. After reading this description, it will become apparent to a person skilled in the relevant art how to implement the invention using other computer systems and/or computer architectures.

Computer system 700 includes one or more processors, such as processor 710. Processor 710 can be a special-purpose or a general-purpose processor. Processor 710 is connected to a communication infrastructure 720 (for example, a bus or network).

Computer system 700 also includes a main memory 730, preferably random access memory (RAM), and may also include a secondary memory 740. Secondary memory 740 may include, for example, a hard disk drive 750, a removable storage drive 760, and/or a memory stick. Removable storage drive 760 may comprise a floppy disk drive, a magnetic tape drive, an optical disk drive, a flash memory, or the like. The removable storage drive 760 reads from and/or writes to a removable storage unit 770 in a well-known trimmer. Removable storage unit 770 may comprise a floppy disk, magnetic tape, optical disk, etc. which is read by and written to by removable storage drive 760. As will be appreciated by persons skilled in the relevant art(s), removable storage unit 770 includes a computer-usable storage medium having stored therein computer software and/or data.

In alternative implementations, secondary memory 750 may include other similar means for allowing computer programs or other instructions to be loaded into computer system 700. Such means may include, for example, a removable storage unit 770 and an interface 720. Examples of such means may include a program cartridge and cartridge interface (such as that found in video game devices), a removable memory chip (such as an EPROM, or PROM) and associated socket, and other removable storage units 770 and interfaces 720 which allow software and data to be transferred from the removable storage unit 770 to computer system 700.

Computer system 700 may also include a communication and network interface 780. Communication interface 780 allows software and data to be transferred between computer system 700 and external devices. Communication interface 780 may include a modem, a communication port, a PCMCIA slot and card, or the like. Software and data transferred via communication interface 780 are in the form of signals which may be electronic, electromagnetic, optical, or other signals capable of being received by communication interface 780. These signals are provided to communication interface 780 via a communication path 785. Communication path 785 carries signals and may be implemented using wire or cable, fiber optics, a phone line, a cellular phone link, an RF link or other communication channels.

The network interface 780 allows the computer system 700 to communicate over communication networks or mediums such as LANs, WANs the Internet, etc. The network interface 780 may interface with remote sites or networks via wired or wireless connections.

In this document, the terms “computer program medium” and “computer usable medium” are used to generally refer to media such as removable storage unit 770, removable storage drive 760, and a hard disk installed in hard disk drive 750. Signals carried over communication path 785 can also embody the logic described herein. Computer program medium and computer usable medium can also refer to memories, such as main memory 730 and secondary memory 740, which can be memory semiconductors (e.g. DRAMs, etc.). These computer program products are means for providing software to computer system 700.

Computer programs (also called computer control logic) are stored in main memory 730 and/or secondary memory 740. Computer programs may also be received via communication interface 780. Such computer programs, when executed, enable computer system 700 to implement the claimed invention as discussed herein. In particular, the computer programs, when executed, enable processor 710 to implement the processes of the claimed invention, such as the steps in the methods illustrated by flowcharts in figures discussed above. Accordingly, such computer programs represent controllers of the computer system 700. Where the invention is implemented using software, the software may be stored in a computer program product and loaded into computer system 700 using removable storage drive 760, interface 720, hard disk drive 750 or communication interface 780.

The computer system 700 may also include input/output/display devices 790, such as keyboards, monitors, pointing devices, etc.

The invention is also directed to computer program products comprising software stored on any computer useable medium. Such software, when executed in one or more data processing device(s), causes a data processing device(s) to operate as described herein. Embodiments of the invention employ any computer useable or readable medium, known now or in the future. Examples of computer useable mediums include, but are not limited to primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The claimed invention can work with software, hardware, and/or operating system implementations other than those described herein. Any software, hardware, and operating system implementations suitable for performing the functions described herein can be used.

### 6. Conclusion

It is to be appreciated that the Detailed Description section, and not the Summary and Abstract sections, is intended to be used to interpret the claims. The Summary and Abstract sections may set forth one or more, but not all, exemplary embodiments of the claimed invention as contemplated by the inventor(s), and, thus, are not intended to limit the claimed invention and the appended claims in any way.

The claimed invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation and without departing from the general concept of the claimed invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the claimed invention should not be limited by any of the above-described exemplary embodiments, but should be defined only in accordance with the following claims and their equivalents.

1. A computer-implemented method for generating an access plan, comprising:
providing a plurality of subsets of a query, each subset including a plurality of partitions;
enumerating, using at least one thread, each partition of each subset;
generating, using at least one thread, at least one physical access plan for each enumerated partition in parallel, wherein a number of threads that perform the enumerating and the generating is dynamically adapted according to a pool of threads available during the enumerating and the generating and a complexity of the query; and
determining the access plan for the query from the at least one generated physical access plan.

2. The computer-implemented method of claim 1, further comprising:
generating a query hypergraph; and
determining each subset from the query hypergraph.

3. The computer-implemented method of claim 1, wherein the enumerating further comprises:
determining an enumerated subset in the plurality of subsets, the enumerated subset including the plurality of enumerated partitions; and
initializing generating of at least one physical access plan for the enumerated subset in parallel with enumerating a plurality of partitions in remaining subsets of the plurality of subsets, wherein the enumerating and the generating is performed using different threads when a plurality of threads in the thread pool are available.

4. The computer-implemented method of claim 1, further comprising:
completing enumerating of the plurality of partitions in each subset prior to generating at least one physical access plan for each enumerated partition.

5. The computer-implemented method of claim 1, wherein the generating further comprises:
generating, using a first thread, a first physical access plan for a first enumerated partition associated with a first subset;
generating, using a second thread, a second physical access plan for a second enumerated partition associated with a second subset in parallel with generating the first physical access plan when a plurality of threads in the thread pool are available, wherein the first subset is not the same as the second subset.

6. The computer-implemented method of claim 1, wherein the generating further comprises:
generating, using a first thread, a physical access plan using at least one enumerated partition wherein the at least one enumerated partition is a union of a first subset and a second subset and wherein the first subset and the second subset comprise a first set; and
enumerating, using a second thread, at least one partition of a second set, wherein the second set is not a subset of either the first subset or the second subset, and wherein generating the physical access plan of the first set is in parallel with enumerating the at least one partition of the second set, when a plurality of threads in the thread pool are available.

7. The computer-implemented method of claim 1, wherein the enumerating further comprises:
enumerating, using a first thread, a plurality of partitions associated with a first subset; and
enumerating, using a second thread, a plurality of partitions associated with a second subset in parallel with the first subset, wherein the first subset is disjoint from the second subset.

8. The computer-implemented method of claim 1, further comprising:
manipulating data in a database using the access plan determined for the query; and
transmitting a result of the manipulation to a recipient device.

9. A system for generating an access plan, comprising:
a query optimizer configured to:
provide a plurality of subsets of a query, each subset including a plurality of partitions;
initialize, using at least one thread, a plan enumeration phase, the plan enumeration phase configured to enumerate each partition of each subset;
initialize, using at least one thread, a plan generation phase, the plan generation phase configured to generate at least one physical access plan for each enumerated partition in parallel with the plan enumeration phase, wherein a number of threads that perform the plan enumeration phase and the plan generation phase is dynamically adapted according to a pool of threads available during the plan enumeration phase and the plan generation phase, and a complexity of the query; and
determine the access plan for the query from at least one generated physical access plan.

10. The system of claim 9, wherein the query optimizer is further configured to:
generate a query hypergraph; and
determine each subset from the query hypergraph.

11. The system of claim 9, wherein the plan enumeration phase is further configured to:
determine an enumerated subset in the plurality of subsets, the enumerated subset including the plurality of enumerated partitions; and
initialize the plan generation phase for an at least one physical access plan for the enumerated subset, wherein the plan enumeration phase is configured to enumerate a plurality of partitions in remaining subsets of the plurality of subsets, and wherein the plan enumeration phase and the plan generation phase is performed in parallel using different threads when a plurality of threads in the thread pool are available.

12. The system of claim 9, wherein the query optimizer is further configured to complete the plan enumeration phase for the plurality of partitions in each subset prior to initializing the plan generation phase; and
wherein the plan generation phase is further configured to generate the at least one physical access plan for each enumerated partition.

13. The system of claim 9, wherein the plan generation phase is further configured to:
generate, using a first thread, a first physical access plan for a first enumerated partition associated with a first subset;
generate, using a first thread, a second physical access plan for a second enumerated partition associated with a second subset in parallel with the first physical access plan when a plurality of threads in the thread pool are available, wherein the first subset is not the same as the second subset.

14. The system of claim 9, wherein the query optimizer is further configured to:
cause the plan generation phase to generate, using a first thread, a physical access plan using at least one enumerated partition, wherein the at least one enumerated partition is a union of a first subset and a second subset, and wherein the first subset and the second subset comprise a first set; and
cause the plan enumeration phase to enumerate, using a first thread, at least one partition of a second set, wherein the second set is not a subset of either the first subset or the second subset, and wherein the plan generation phase generates the physical access plan of the first set and the plan enumeration phase enumerates at least one partition of the second set in parallel when a plurality of threads in the thread pool are available.

15. The system of claim 9, wherein the plan enumeration phase is further configured to:
enumerate, using a first thread, a plurality of partitions associated with a first subset; and
enumerate, using a second thread, a plurality of partitions associated with a second subset in parallel with the first subset, wherein the first subset is disjoint from the second subset, and when a plurality of threads in the thread pool are available.

16. The system of claim 9, further comprising an execution unit configured to:
manipulate data in a database using the access plan for the query, the access plan determined by the query optimizer;
generate a result of the manipulation; and
transmit the result to a recipient device.

17. A computer-readable medium, having instructions stored thereon, wherein the instructions cause a computing device to perform operations for generating an access plan, comprising:
providing a plurality of subsets of a query, each subset including a plurality of partitions;
enumerating, using at least one thread; each partition of each subset;
generating, using at least one thread, at least one physical access plan for each enumerated partition in parallel, wherein a number of threads that perform the enumerating and the generation is dynamically adapted according to a pool of threads available during the enumerating and the generating and a complexity of the query; and
determining the access plan for the query from the at least one generated physical access plan.

18. The computer-readable medium of claim 17, wherein the enumerating further comprises:
determining an enumerated subset in the plurality of subsets, the enumerated subset including the plurality of enumerated partitions; and
initializing generating of at least one physical access plan for the enumerated subset in parallel with enumerating a plurality of partitions in remaining subsets of the plurality of subsets, wherein the enumerating and the generating is performed using different threads when a plurality of threads in the thread pool are available.

19. The computer-readable medium of claim 17, wherein the generating further comprises:
generating, using a first thread, a first physical access plan for a first enumerated partition associated with a first subset;
generating, using a second thread, a second physical access plan for a second enumerated partition associated with a second subset in parallel with generating the first physical access plan when a plurality of threads in the thread pool are available, wherein the first subset is not the same as the second subset.

20. The computer-readable medium of claim 17, wherein the generating further comprises:
generating, using a first thread, a physical access plan using at least one enumerated partition wherein the at least one enumerated partition is a union of a first subset and a second subset and wherein the first subset and the second subset comprise a first set; and
enumerating, using a second thread, at least one partition of a second set, wherein generating the physical access plan of the first set is in parallel with enumerating at least one partition of the second set, wherein the second set is not a subset of either the first subset or the second subset and when a plurality of threads in the thread pool are available.
